(19) United States
(12) Patent Application Publication
(10) Pub. No.: US 2026/0285280 A1
(43) Pub. Date: Sep. 24, 2026

(54) ACTUATION OF AN ELECTROMECHANICAL PARKING BRAKE, IN PARTICULAR FOR USE IN A MOTOR VEHICLE

(71) Applicant: Robert Bosch GmbH, Stuttgart (DE)

(72) Inventors: Frank Baehrle-Miller, Schoenaich (DE); Tobias Putzer, Flein (DE)

(21) Appl. No.: 19/566,075

(22) Filed: Mar. 13, 2026

(30) Foreign Application Priority Data
Mar. 24, 2025 (DE) 10 2025 111 268.1

(51) Int. Cl. B60T 13/74; B60T 17/22

(52) U.S. Cl. CPC B60T 13/746; B60T 17/22

(57) ABSTRACT

A method for actuating an electromechanical parking brake, in particular for use in a motor vehicle. The method includes: detecting a user-side actuation request; producing a specified clamping force by moving at least one brake pad relative to a brake disc or brake drum into a holding position via a drive mechanism; activating a locking mechanism to secure the brake pad in the holding position, preferably by latching a locking pawl into a ratchet wheel; releasing, in particular gradually reducing, the clamping force provided by the drive mechanism; outputting an actuation confirmation to the user.

### CROSS REFERENCE

The present application claims the benefit under 35 U.S.C. § 119 of Germany Patent Application No. DE 10 2025 111 268.1 filed on March 24, 2025, which is expressly incorporated herein by reference in its entirety.

### FIELD

The present disclosure relates to a method for actuating an electromechanical parking brake, in particular for use in a motor vehicle. The present disclosure further relates to a control device for controlling an electromechanical parking brake. The present disclosure also relates to an electromechanical parking brake.

### BACKGROUND INFORMATION

Certain electromechanical brake systems (EMB) for use in motor vehicles are conventional. These systems use an electromotive drive mechanism, for example in the form of an electronically commutated motor (EC machine), to move or shift a brake pad in the direction of a brake disc or brake drum via a reduction gear and via a rotation-translation gear, such as a ball screw drive (KGT), to create friction and thus generate a braking force or deceleration. Conversely, the brake pad can be moved or shifted away from the brake disc or brake drum to reduce or eliminate friction and the resulting deceleration. The vehicle can thus generate and release braking forces according to a request from the driver by regulating the electromotive drive mechanism.

Certain conventional electromechanical brake systems are designed to be as non-self-locking or as low self-locking as possible. The objective is that, in the event of an electromechanical failure, the respective brake releases the braked wheel and travel can be continued; possibly with the output of a corresponding warning to the driver or user about the malfunction or functional failure of the electromechanical brake. Conventionally, electromechanical brake devices can also be used as parking brakes or holding brakes. Since the parking brake function or holding brake function has to operate without energy or be maintained without energy, the related art uses the electromechanical brake device to set a target clamping force between the brake pad and the brake disc/brake drum, and then locks the mechanical action path from the electromotive drive mechanism to the clamping partners, i.e. to the brake pad and the brake disc/brake drum. This locking can be achieved either by friction or by form-locking.

Germany Patent Application No. DE 198 54 105 A1 describes a method for actuating an electric parking brake, in which an actuation command for applying or releasing the parking brake is output using an unlocked pulse generator, for example a button. The execution of the command, the state of the parking brake and/or the proper functioning or a malfunction of the system are reported and signaled by means of an electrically actuatable, for example bistable, indicator element which remains in the respective switching position without energy consumption.

Since the electromechanical drive mechanism is typically used in electromechanical brake devices for both the service brake and the parking brake, the starting positions of the brake pad relative to the brake disc or brake drum at the time of the user-side actuation request to actuate or activate the parking brake are very different. A statically specified moving of the brake pad to activate or actuate the electromechanical parking brake could therefore cause the involved components, such as the drive mechanism, to be subjected to excessive stress, consume too much energy, and complete the actuation or activation of the parking brake at different speeds. This can not only cause confusion for the user due to noticeably different speeds of actuation or activation of the parking brake, but can also lead to unnecessary or excessive wear of the components and parts of the electromechanical parking brake.

An object of the present disclosure is to overcome the disadvantages of the related art and in particular enable improved actuation of an electromechanical parking brake.

### SUMMARY

A method according to the present disclosure for actuating an electromechanical parking brake enables a dynamic configuration of the actuation, in which it is not the actuation itself or the individual steps for actuation that are specified, but rather the time or duration, i.e., a time interval, in which the actuation has to be completed and feedback has to be output to the user. This enables the actual actuation or activation of the electromechanical parking brake to be optimized and carried out in a resource-saving and material-conserving manner within the available time interval between the actuation request and the output of an actuation confirmation. This moreover also achieves the particular advantage that the user always receives the output of an actuation confirmation after a fixed time interval following the user-side actuation request, so that a correspondingly high degree of user confidence in the safe and reliable generation of the braking effect of the electromechanical parking brake is achieved.

The method according to an example embodiment of the present disclosure for actuating an electromechanical parking brake, in particular for use in a motor vehicle, comprises the following steps, which are preferably but not necessarily carried out in the sequence stated in the following:

detecting a, preferably user-side, actuation request for actuating the electromechanical parking brake, preferably via a switching unit.

According to an example embodiment, actuating a switching unit can be switching the driving mode to "P" on a driving mode selector, for example. Alternatively to the activation of a switching unit, the actuation request for the electromechanical parking brake can also be initiated via another user-side action that does not directly require activation of a switching unit of the parking brake. For example, it is also possible that the actuation request is initiated by the driver unbuckling their seatbelt, opening the driver side door or leaving the driver seat. It is also possible that, as part of an automated parking procedure, the actuation request is automatically generated after the final parking position is reached.

Producing a specified clamping force by moving at least one brake pad relative to a brake disc or brake drum into a holding position via a, preferably electromechanical, drive mechanism. Activating a locking mechanism to secure the brake pad in the holding position, preferably by latching a locking pawl into a ratchet wheel. Releasing, in particular gradually reducing, the clamping force provided by the drive mechanism. Releasing the clamping force provided by the drive mechanism can preferably be achieved by releasing or reducing the motor torque of the drive mechanism. Outputting an actuation confirmation to the user, preferably via an optical and/or acoustic output unit.

According to the present disclosure, it is provided that, regardless of the initial state of the electromechanical parking brake, the actuation confirmation is output after a fixed time interval following the actuation request, wherein the locking mechanism is activated and/or the clamping force of the drive mechanism is released when or at the time at which the output occurs. This particularly advantageously enables not only consistent, in particular consistently fast, feedback to the user regarding the successful activation or actuation of the parking brake, but also enables the individual steps for actuation to be optimized or at least adjusted, depending on the initial state of the electromechanical parking brake.

In a first advantageous example embodiment of the method, it can be provided that the locking mechanism is checked within the fixed time interval prior to output of the actuation confirmation, in particular by checking the movement state of the drive mechanism. As already discussed above, a suitable electric motor can be used as the drive mechanism. When the locking mechanism is activated and the electromechanical parking brake is thus actuated, a state of equilibrium is established when or after the clamping force is reduced by the drive mechanism. Once this state of equilibrium is achieved, there may be no further movement on the part of the drive mechanism. This, i.e. the movement state of the drive mechanism, can be used to reliably determine whether the parking brake has been correctly actuated and the locking mechanism is activated.

The movement of the drive mechanism can be identified via an evaluation of the voltage and current states on the corresponding electric motor, for example. Other sensor devices can additionally or alternatively be provided as well to acquire and check the movement state of the drive mechanism.

Another advantageous example embodiment of the method can provide that producing the specified clamping force and/or activating the locking mechanism is carried out in an energy-optimized manner, in particular as quickly as possible. From the time at which the locking mechanism is active and the clamping force is completely released by the drive mechanism, the electromotive drive is no longer being controlled and therefore no longer requires current or electrical energy. For energy-optimized activation of the electromechanical parking brake, it can therefore be particularly advantageous if producing the specified clamping force and activating the locking mechanism and possibly also releasing or reducing the clamping force is carried out as quickly as possible. Particularly when the clamping force is already partially or fully applied in the initial state— for example, when the parking brake is actuated or activated while the brake pedal of the service brake is being actuated—this can lead to producing the specified clamping force, activating the locking mechanism and then releasing the clamping force being completed well before the end of the fixed time interval. In this case, provision is made according to the present disclosure that the actuation confirmation is still output only after the fixed time interval has elapsed, in order not to confuse the user about the successful actuation if the confirmation is output too quickly or too early.

Conversely, the fixed time interval can be specified or defined such that, even for an initial state with a fully open electromechanical brake, the clamping force can be produced, the locking mechanism can be activated and, if necessary, the clamping force can be released again, before the actuation confirmation is output. Other influencing factors, such as the operating temperature of the electromechanical parking brake and/or a voltage level of the electromechanical parking brake, can also be taken into account in order to enable reliable and safe activation within the fixed time interval in every case.

In another, likewise advantageous example embodiment, it can be provided that producing the specified clamping force and/or activating the locking mechanism is carried out in a load-optimized manner, in particular by making the most complete use possible of an available fixed time interval. This advantageously makes it possible to take the respective initial state of the electromechanical parking brake into account and carry out the activation or actuation of the parking brake in such a way that the total available time interval or individual subintervals are utilized as completely as possible. This avoids high loads on the drive mechanism, in particular the electric motor. The rotational speed can be increased correspondingly slowly and also reduced slowly again after the specified clamping force is reached. This also ensures that high accelerations on the part of the locking mechanism are avoided. The electrical current needed to actuate the locking mechanism can be adjusted accordingly so that moving parts of the locking mechanism are not moved hard into mechanical end stops.

Another particularly advantageous example embodiment of the method can, as already indicated above, provide that the control of the drive mechanism and/or the control of the locking mechanism are determined or optimized depending on the initial state of the electromechanical parking brake and taking into account the time interval. If the entire available fixed time interval is to be fully utilized, for instance, the initial state can be acquired and the control of the drive mechanism for producing and releasing the clamping force and the control of the locking mechanism can be optimized, for example energy-optimized and load-optimized, depending on the initial state.

As also described above, an advantageous example embodiment of the method can include the initial state of the parking brake being ascertained by ascertaining the position of the drive mechanism and/or the at least one brake pad and/or a level of a supply voltage of the parking brake and/or a temperature of the parking brake. With regard to the temperature of the parking brake, the operating temperature of the electromechanical components is particularly advantageously recorded.

The abovementioned indicators are particularly well-suited to as accurately as possible acquire or at least approximate the initial state based on both static conditions and dynamically changeable properties of the electromechanical parking brake. The acquisition and evaluation of these properties and measured values with respect to the initial state can particularly advantageously be used to optimize or adjust the activation of the parking brake and the individual method steps, in order to ensure that the activation is still completed by the end of the fixed time interval and the output of the actuation confirmation can take place.

The present disclosure also leads to a control device for controlling an electromechanical parking brake, comprising connections to a switching unit for a user-side actuation request for the parking brake, and to an optical and/or acoustic output unit for outputting an actuation confirmation about an actuation of the parking brake to a user and at least one connection to sensor means (i.e., a sensor) that identify and/or monitor a state of the parking brake. According to the present disclosure, it is provided that the control device is configured to activate the parking brake and generate an output of the actuation confirmation after a fixed time interval following the actuation request, wherein the locking mechanism is activated and/or the clamping force of the drive mechanism is released when the actuation confirmation is output. The control device according to the present disclosure ensures, on the one hand, that the parking brake is activated or actuated and, on the other hand, that the actuation confirmation is reliably and verifiably output to the user after a fixed time or a fixed time interval.

This particularly advantageously also makes it possible that, depending on the initial state of the parking brake, optimization is carried out while at the same time adhering to or maintaining the fixed time interval.

In an advantageous example embodiment of the control device, it can be provided that it is configured to carry out a method according to one of the above-described embodiments.

The present disclosure also includes an electromechanical parking brake, in particular for use in a motor vehicle, wherein the electromechanical parking brake comprises a control device according to one of the above-described embodiments. As already described above, particularly advantageously for the user, the parking brake according to the present disclosure generates and outputs constant feedback in the form of the actuation confirmation, which at the same time creates the opportunity to optimize the activation of the parking brake and in particular make it dependent on the initial state.

Further advantages, features, and details of the present disclosure will emerge from the following description of preferred embodiments of the present disclosure and with reference to the figure.

### BRIEF DESCRIPTION OF THE DRAWING

FIG. 1 shows a chronological sequence for activating an electromechanical parking brake according to different example embodiments.

### DETAILED DESCRIPTION OF EXAMPLE EMBODIMENTS

The same elements or elements having the same function are provided with the same reference signs in the figure.

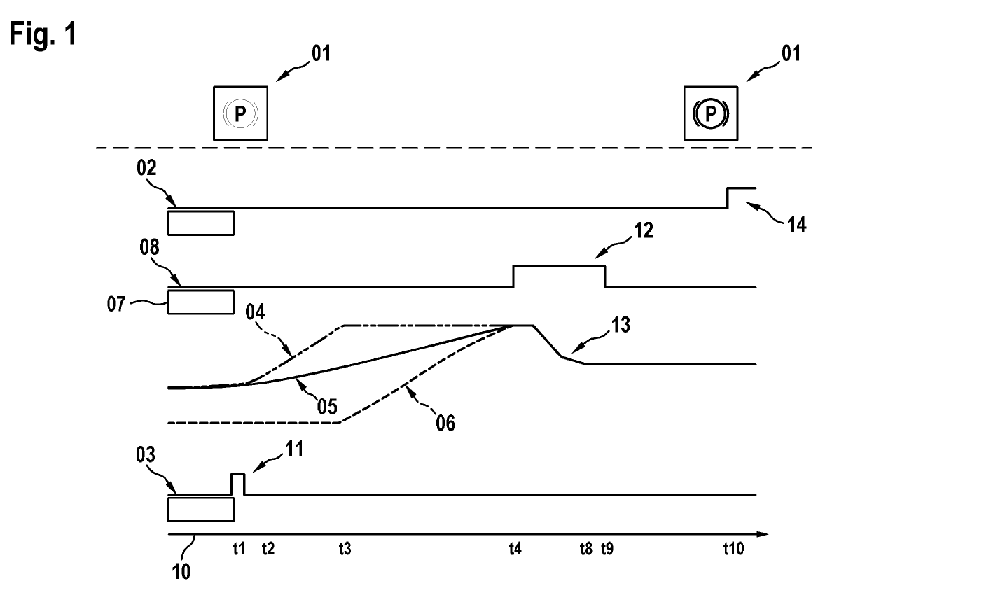

FIG. 1 shows a temporally resolved flow chart for the actuation or activation of an electromechanical parking brake. The time axis 10 shows the prevailing states, properties, and method steps at specific times. At a time t1, an example of an optical output unit 01 with a commonly-used parking brake symbol is not activated, i.e. not switched on or backlit. The first function progression symbolizes the state of the output unit 01 or the function progression of the output unit in the time interval between the time t1 and the time t10.

It can be seen that, at the fixed time t10, the actuation confirmation is output to the user by activating or backlighting the optical output unit 01. This specifies a fixed time interval t10-t1 within which the parking brake is activated and the actuation confirmation is output. In a function progression of the actuation request 03 of the electromechanical parking brake shown in the bottom signal row in the time diagram of FIG. 1, a user can see that the actuation request 11 is made at the time t1 via a not more closely depicted switching unit. FIG. 1 also shows a first clamping force progression 04, a second clamping force progression 05 and a third clamping force progression 06. In the first clamping force progression 04 and the second clamping force progression 05, clamping forces are already present between the brake pad and the brake disc or brake drum at the time t1. This state occurs when the parking brake is actuated or activated while the user or driver is still actuating the brake pedal of the service brakes, for instance.

The first clamping force progression 04 shows the fastest possible increase of the clamping force to a specified clamping force 07. Although not shown like this in FIG. 1, the locking mechanism 12 can already be activated at the time t3, for example, at which the maximum value or the specified clamping force 07 is reached. In this case, the drive mechanism is completely deactivated within a short time after the clamping force has decreased again and the locking mechanism has taken over holding the clamping force. This enables energy-optimized activation of the parking brake, even if the fixed time interval t10-t1 has not yet elapsed or run down after the activation has been completed.

The second clamping force progression 05 shows an alternative configuration for activating the parking brake. In the second clamping force progression 05, the clamping force is increased in a load-optimized manner and high accelerations on the part of the drive mechanism are avoided. The rotational speed of the drive mechanism is slowly increased until the target clamping force or the specified clamping force 07 is reached.

In the third clamping force progression 06, in the same way as in the first clamping force progression 04, but starting from a "fully open" electromechanical brake/service brake, the clamping force is increased quickly and in an energy-optimized manner until the specified clamping force 07 is reached at the time t4.

The progression of the locking mechanism activation 08 shows that, in the example of FIG. 1, the locking mechanism 12 is activated at the time t4, which initiates the securing of the brake pad in the holding position, preferably by latching a locking pawl into a ratchet wheel. With regard to the first clamping force progression 04, this activation could also already take place at the time t3 in the progression of the locking mechanism activation 08 as described above.

Between the time t4 and the time t8, the clamping force on the drive mechanism 13 side is released, in particular gradually reduced. The reduction of the clamping force is advantageously achieved by decreasing or eliminating the motor torque of the drive mechanism. After the state of equilibrium between the locking mechanism and the clamping partners (brake pad and brake disc or brake pad and brake drum) is reached, a sensor can be used to determine, for example at the time t9, whether the drive mechanism is still moving or stationary. This checks the movement state of the drive mechanism.

At the time t10, which is fixed as the interval from the time t1 and unchanging or invariable as the time interval t10-t1, the output unit 01 is activated according to the function progression of the output unit 02, so that the actuation of the parking brake is output to the user or the actuation confirmation is output 14.

FIG. 1 shows that a fixed time interval t10 – t1 provides various ways to modify the clamping force progressions 04, 05 and 06 and at the same time ensure that the actuation confirmation can be reliably output at the time t10 after activation of the parking brake. It in particular makes it possible to take into account the initial state, which is represented by the different starting points of the first clamping force progression 04 and the third clamping force progression 06 at the time t1, in order to use a specific optimization, for example load optimization, energy optimization, or some other way, to adjust the clamping force in an optimized manner and thus adjust the clamping force progression.

The initial state of the clamping force at the time t1 can, for instance, be determined and/or approximated by ascertaining and/or taking into account the position of the drive mechanism and/or the brake pads and/or a level of a supply voltage of the parking brake and/or a temperature of the parking brake, in particular an operating temperature of the electromechanical components.

What is claimed is:

1. A method for actuating an electromechanical parking brake for use in a motor vehicle, comprising the following steps:
detecting a user-side actuation request;
producing a specified clamping force by moving a brake pad relative to a brake disc or brake drum into a holding position via a drive mechanism;
activating a locking mechanism to secure the brake pad in the holding position;
releasing, including gradually reducing, the clamping force provided by the drive mechanism; and
outputting an actuation confirmation to a user;
wherein, regardless of an initial state of the electromechanical parking brake, the actuation confirmation is output after a fixed time interval following the actuation request, and wherein when the output occurs, the locking mechanism is activated and/or the clamping force of the drive mechanism is released.

2. The method according to claim 1, wherein the detecting of the user-side actuation request is via a switching unit, wherein the locking mechanism secures the brake pad in the holding position by latching a locking pawl into a ratchet wheel, and wherein the outputting of the actuation confirmation is via an optical output unit and/or an acoustic output unit.

3. The method according to claim 1, wherein the locking mechanism is checked within the fixed time interval prior to output of the actuation confirmation, by checking the movement state of the drive mechanism.

4. The method according to claim 1, wherein at least one of: (i) the producing of the specified clamping force, (ii) the activating of the locking mechanism, or (iii) the releasing of the clamping force, is carried out in an energy-optimized manner.

5. The method according to claim 1, wherein at least one of: (i) the producing of the specified clamping force, (ii) the activating of the locking mechanism, or (iii) the releasing of the clamping force, is carried out in a load-optimized manner, by making a most complete use possible of an available subinterval.

6. The method according to claim 1, wherein control of at least one of: (i) the drive mechanism, or (ii) the locking mechanism, are determined or optimized depending on the initial state of the electromechanical parking brake and taking into account the fixed time interval.

7. The method according to claim 1, wherein the initial state of the parking brake is ascertained by ascertaining at least one of: (i) a position of the drive mechanism, (ii) a position of the brake pads, (iii) a level of a supply voltage of the parking brake, or (iv) a temperature of the parking brake.

8. A control device for controlling an electromechanical parking brake, comprising:
connections to a switching unit for a user-side actuation request for the parking brake, and to an optical and/or acoustic output unit for outputting an actuation confirmation about an actuation of the parking brake to a user;
at least one connection to a sensor configured to identify and/or monitor a state of the parking brake;
wherein the control device is configured to activate the parking brake and generate an output of the actuation confirmation after a fixed time interval following the actuation request, wherein a locking mechanism is activated and/or the clamping force of the drive mechanism is released when the actuation confirmation is output.

9. The control device according to claim 8, wherein the control device is configured to:
detect the user-side actuation request;
produce a specified clamping force by moving a brake pad relative to a brake disc or brake drum into a holding position via a drive mechanism;
activate the locking mechanism to secure the brake pad in the holding position;
release, including gradually reducing, the clamping force provided by the drive mechanism; and
output an actuation confirmation to the user.

10. An electromechanical parking brake for use in a motor vehicle, comprising:
a control device for controlling the electromechanical parking brake, including:
connections to a switching unit for a user-side actuation request for the parking brake, and to an optical and/or acoustic output unit for outputting an actuation confirmation about an actuation of the parking brake to a user;
at least one connection to a sensor configured to identify and/or monitor a state of the parking brake;
wherein the control device is configured to activate the parking brake and generate an output of the actuation confirmation after a fixed time interval following the actuation request, wherein a locking mechanism is activated and/or the clamping force of the drive mechanism is released when the actuation confirmation is output.
